(19) United States
(12) Patent Application Publication
(10) Pub. No.: US 2015/0276426 A1
(43) Pub. Date: Oct. 1, 2015

(54) Map of Contents

(71) Applicant: Vinay Krishnaswamy, Woodinville, WA (US)

(72) Inventor: Vinay Krishnaswamy, Woodinville, WA (US)

(21) Appl. No.: 14/224,445

(22) Filed: Mar. 25, 2014

(51) Int. Cl. G01C 21/36; G06F 3/0484; G06F 3/0482

(52) U.S. Cl. CPC G01C 21/3697; G06F 3/0482; G06F 3/04842

(57) ABSTRACT

A technique to present a map of contents is provided. A map of contents with a plurality of selection areas is presented to a user, and upon the user's selection of one of the plurality of selection areas, at least one content associated with the selection is presented to the user. The map of contents may depict a geographic map or an arbitrary graphic.

### FIELD

This application relates to a Map of Contents.

### BACKGROUND

The Internet provides a foundation for people wishing to share pictures, text, multimedia, or other content with others.

It is often easy for an individual to post pictures or write a blog, although producing a well-designed product often requires special skills, which many individuals do not have.

### BRIEF SUMMARY

The present application provides, among other things, a Map of Contents. The Map of Contents may have areas that may be selected to bring forth one or more items of content. A user selecting an area on the Map of Contents may be provided with a presentation of one or more items of content associated with the selected area.

One embodiment may include a method that includes creating a map, receiving a first content from a first user and correlating the received first content to a first area of the map. The method may also include receiving an indication selecting the first area of the map from a second user and presenting the first content to the second user.

In one aspect of an embodiment, correlating the first content with the first area may be based on an input from the first user. In another embodiment, the first content may be presented on a display device to the second user.

Another embodiment may be a system that may include a content receiving module configured to receive a content from a first user and a processing module configured to generate a map graphic having a plurality of selection areas, which may correlate the content to a first area of the map. The system may further include a memory module coupled to the processing module, a rendering module configured to render the map graphic onto a display device, an input receiving module configured to receive an indication selecting the first area, and an output module configured to output the content.

In yet another embodiment, a system may also include a database module configured to store content. In yet another embodiment, the system may include an access rights module configured to allow assignment of one or more access rights to a user.

### BRIEF DESCRIPTION OF THE DRAWINGS

FIG. 1 is an example of a system in which a Map of Contents may be implemented.

FIG. 2 is an example of a Map of Contents that may be presented to a user according to one embodiment.

FIG. 3 is an example of a Map of Contents that may be presented to a user according to another embodiment.

FIG. 4 is an example of a Map of Contents that may be presented to a user according to yet another embodiment.

FIG. 5 is a flow chart of a process for a Map of Contents according to one embodiment.

FIG. 6 is a flow chart of a process for a Map of Contents according to another embodiment.

FIG. 7 is a block diagram of a computing device according to one embodiment.

### DETAILED DESCRIPTION

Particular details are set forth to provide a thorough understanding of various embodiments of Map of Contents. One skilled in the art will understand, however, that the invention may be practiced without these details.

In the drawings, identical reference numbers identify similar features or elements. The size and relative positions of features in the drawings are not necessarily drawn to scale.

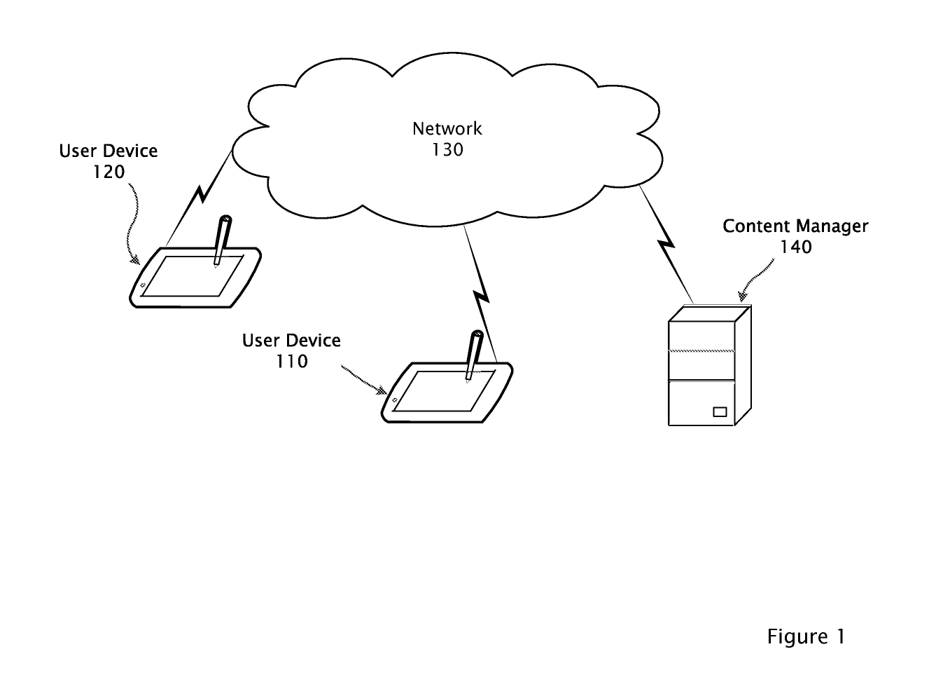

FIG. 1 shows an example of a system 100 in which a Map of Contents may be implemented. The system 100 includes User Device 110 and a Content Manager 140. User Device 110 communicates with the Content Manager 140 via Network 130. The system 100 may also include User Device 120. User Device 110 may be used to create, edit, review, upload, publish or view content. These functions may be performed through the use of a web site, through a dedicated application, or through other means of accessing the Content Manager 140. User Device 120 may function the same way as User Device 110, although User Device 120 having different designs and capabilities than User Device 110 is also contemplated.

Content Manager 140 may be used to store and/or manipulate content and their attributes. Content Manager 140 may also serve content. As shown in FIG. 1, Content Manager 140 may receive content from User Devices 110, 120, and transmit content to User Devices 110, 120. In one embodiment, Content Manager 140 includes a database with tables to store information about users, User Devices, projects, articles, elements, layouts, graphics, links, and other data that may be relevant to providing a Map of Contents.

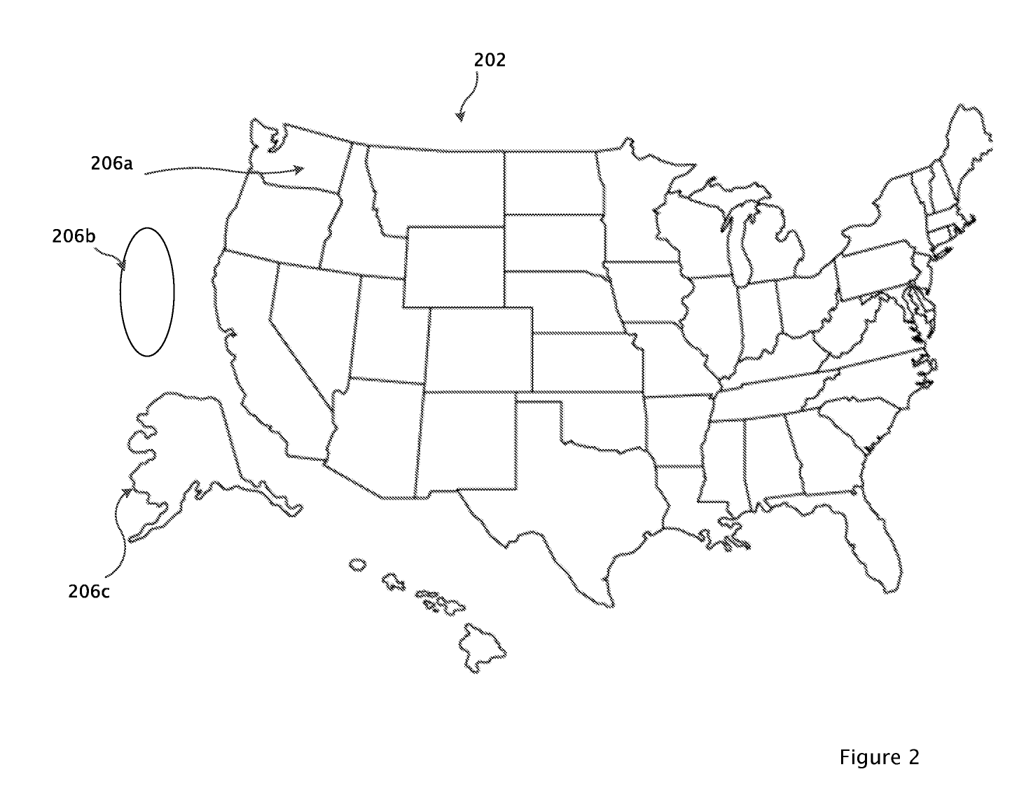

FIG. 2 illustrates one example of a Map of Contents 202, presented as a geographic map of the United States. The Map of Contents 202 may be of any shapes, known or arbitrarily created. The Map of Contents 202 may be a rendered graphic having a plurality of Selection Areas 206a-c. Each of the Selection Areas 206a-c may be of any shape or size. For illustrative purposes, Selection Areas 206a and 206c in FIG. 2 are areas of the Map of Contents 202 bounded by the outline of the states of Washington and Alaska respectively. A Selection Area may not be clearly outlined in the Map of Contents 202. Selection Area 206b, for example, may not be visibly outlined, the area bounded by the dashed line may be considered to be a particular Selection Area 206b.

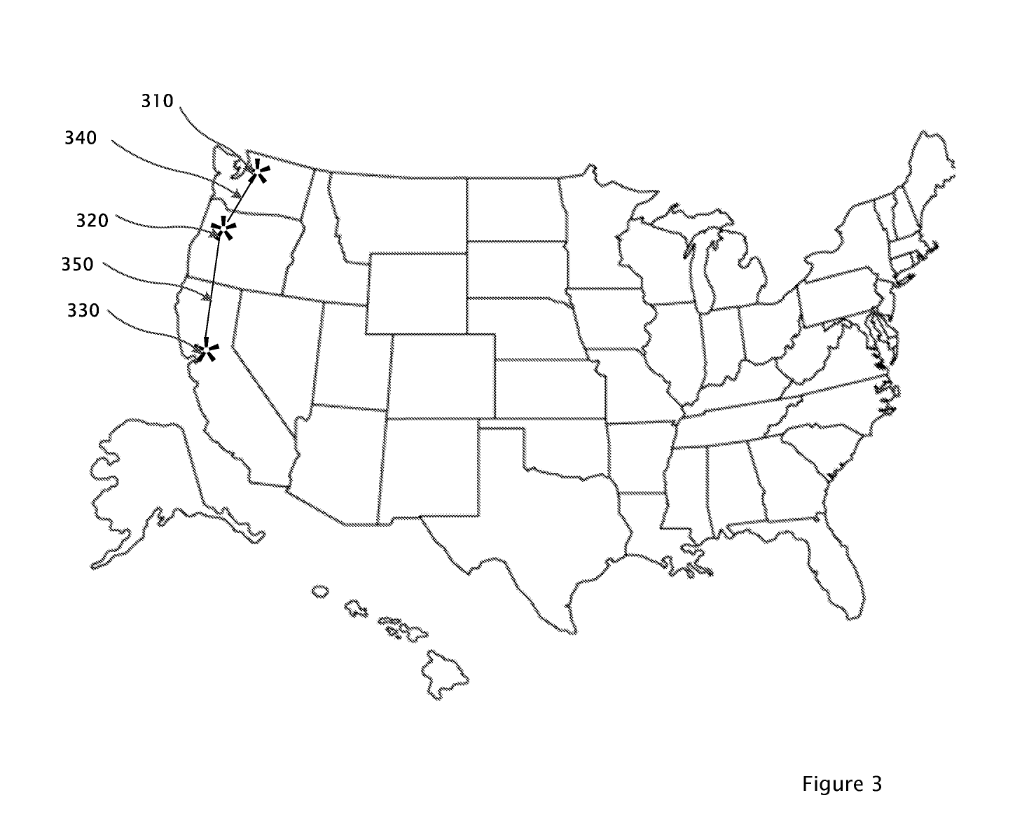

FIG. 3 is an example of a Map of Contents that may be presented to a user according to another embodiment. A Map of Contents may be used to generate a route. For example, if a Map of Contents includes cites such as Seattle 310, Portland 320, and San Francisco 330, Map of Contents may automatically generate a route to travel, such as driving instructions. Map of Contents may illustrate a Road 340 from Seattle 310 to Portland 320, and another Road 350 on to San Francisco 330. Map of Contents may also build a route based on the order entries to a publication are entered. For example, if a first user is traveling along the western seaboard of the United States and writing a blog each day, Map of Contents may provide a route so that second user could follow the same route as the first user. Map of Contents may infer a location from a title of a blog entry, from the first user indicating the location on a map, obtaining information from a GPS or other location identifying device, or by asking the first user.

In another embodiment, a first user may, for example, go on a trip to Washington State. The first user and the first user's family may take many photos, which may be posted to Facebook™, other social networks, or other places on the internet, for example. The first user may decide to write a blog about the trip, and divide it into sections based on various places visited. The first user may launch an auto-create a Map of Contents option. The first user may upload photos for each section, name each section, and may load other content, such as relevant articles previously written.

The first user may launch an auto-created publication of a Map of Contents. A route may be created based on section titles. The Map of Contents may display a pin with GPS information corresponding to one or more of the photos. A second user may select a displayed pin, and jump to a chapter pertaining to a route the corresponding photo is on, or to a page containing the photo, which may not be on a route. Other pins may also be added to link to chapters or other media.

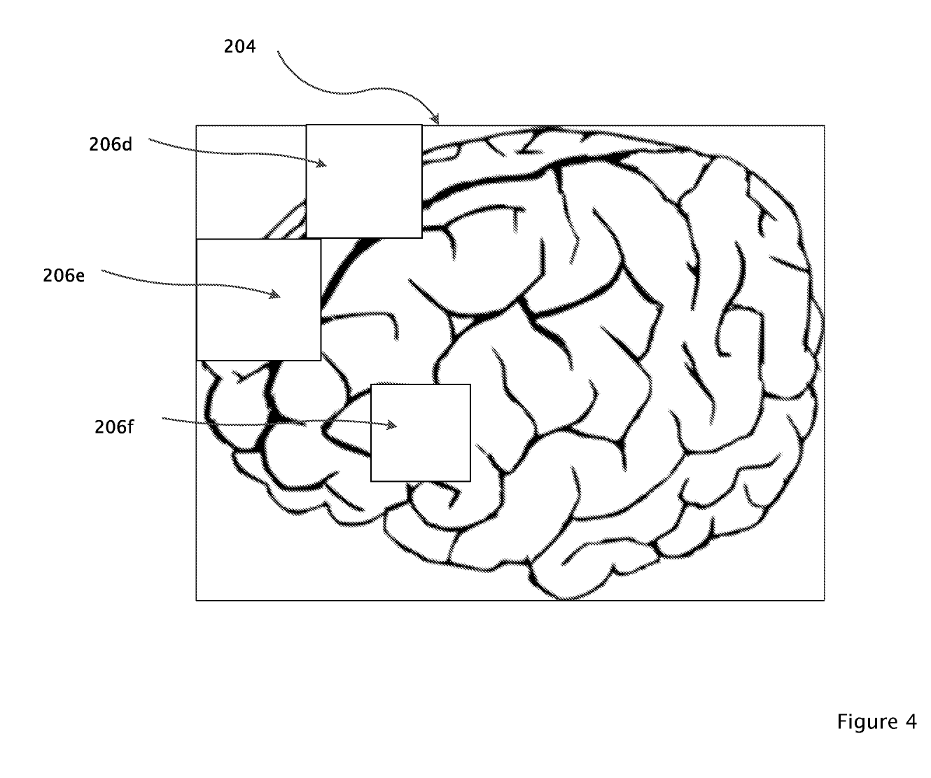

FIG. 4 illustrates another example of a Map of Contents 204. A graphic of a brain may be used as the Map of Contents 204, and areas of the brain may be defined as Selection Areas 206d-f. The rectangular shapes of Selection Areas 206d-f are not meant to be limiting as other shapes for Selection Areas 206d-f are also contemplated. Selection Areas 206d-f may be of the same shapes and size, although varying shapes and sizes of Selection Areas 206d-f are also contemplated. In one embodiment, each part of the Map of Contents is associated with a Selection Area. In another embodiment, only some parts of a Map of Contents are associated with Selection Areas.

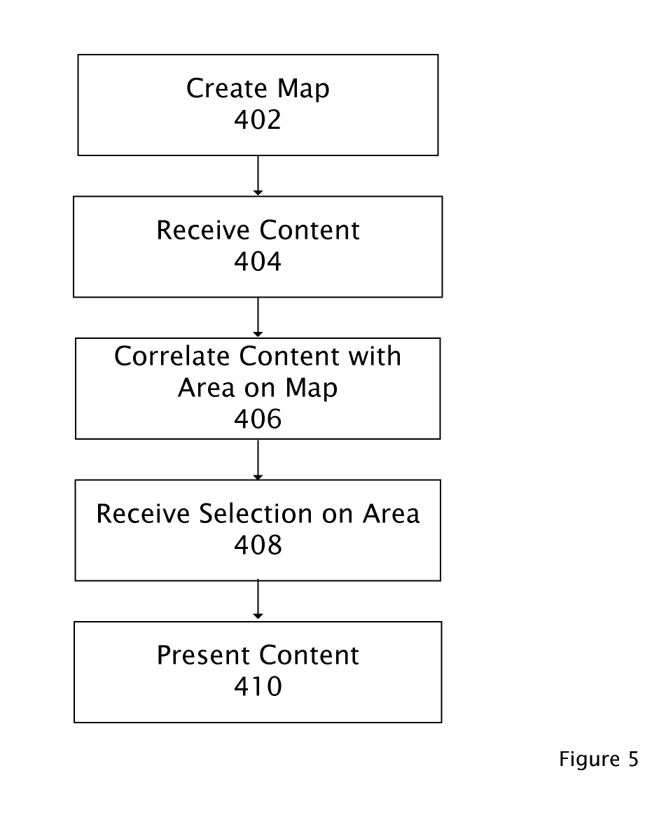

FIG. 5 shows a process to implement the Map of Contents 202, according to one embodiment. A Map may be Created 402, at a processing device. This map may, for example, be based on a graphic created by a user on User Device 110 or a stored template of other graphics. A two dimensional map may be divided into several distinct and non-overlapping areas as shown in FIGS. 2 and 3 previously described. Each of the areas may be able to be addressed and worked on individually. The map and its areas may be stored as one or more files in a storage medium. The file(s) may be renderable as a graphics on a display device, such as User Device 110 or User Device 120. Other display devices are also contemplated.

As a Content is Received 404, it may be Correlated with a particular Selection Area on the Map 406. A content may be a photo, a video, a document, a URL, or other types of information. The content may also be stored on a storage medium. A plurality of content may be received, and each of the plurality of content may be associated with a selection area of the map. One area of the map may be associated with one or more content, and one content may be associated with one or more areas of the map. The correlation or association of a content with one or more selection areas on the map may be determined by the user who created the content. Other individuals may also determine the correlation or association of a content with one or more areas on the map. The correlation between each content and area(s) of the map may be stored in a storage medium.

As more content are received, additional associations may be created for each area of the map, which may link the content with an associated area(s), and the map may become a Map of Contents. A list of all content associated with one area of the map may be created and stored in the storage medium, the list itself being associated with one area.

When a user is presented with a Map of Contents 202, and selects a particular area on the Map of Contents 408, the user may be presented with all content associated with the selected area 410. For example, a user may first be presented with the Map of Contents 202 as illustrated in FIG. 2 on the User Device 110. When the user selects the state of Washington, all content associated with the selected area on the map bounded by the state boundary may be presented on the User Device. The content may include a travel blog about a second user's trip to Washington State, a list of friends and family in Washington State, business opportunities in Washington State, birds in Washington State, or other content related to Washington State. The content may also be completely unrelated to Washington State, and the map and selection area may be used as a Map of Contents of other arbitrary information. The use of a geographical map as the graphic for a Map of Contents is not meant to limit the content available through the Map of Contents. One skilled in the art will recognize that content may be grouped in any way and associated with any area of the map. The content may not be rationally related to the graphic used as the Map of Contents.

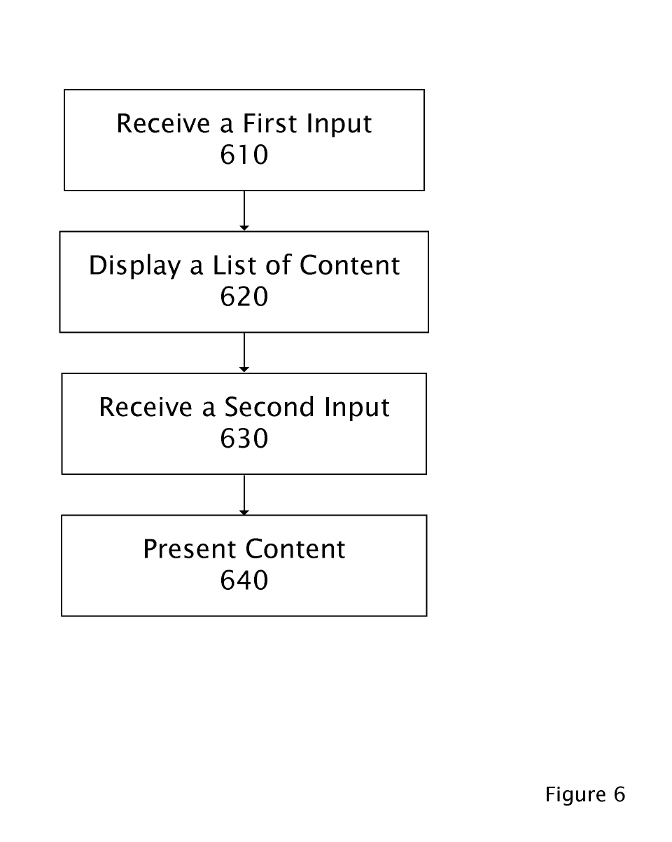

In one aspect of an embodiment, the step Receive Selection of an Area on a Map of Contents 408 may consist of several steps as illustrated in FIG. 6.

FIG. 6 is a flow chart of a process for a Map of Contents according to another embodiment. In this embodiment, a user may make a selection of an area with a mouse or other pointing device. When the mouse is moved over the area, which is known as “hovering,” a First Input may be considered to be Received 610 at a processing device. Upon Receiving the First Input 610, the processing device may Display List of Content 620 associated with the area over which the mouse is hovering. The list may be shown briefly or for a sustained period of time on the display. The list may include all or some of the content associated with the selected area. A Second Input may be Received 630 when a confirmation is made, for example, either by a mouse click or a keyboard entry, confirming that the user wants to see the content in the list. The user may also move the mouse to point to one content in the displayed list before confirming the selection, in which case, the second input may select a particular content to be presented on the display. Upon Receiving the Second Input 630, one or more items of Content may be Presented to the user 640.

In another embodiment, the user may select an area with a touch. When the user, using his finger or another implement, touches an area of the Map of Content, a First Input may be Received 610. A List of Content associated with the touched area may be presented on the Display 620, and when the user touches the same area to confirm his selection, a Second Input may be Received 630.

The process may be performed at User Device 110, 120, at Content Manager 140, a combination of devices, or at a system including one or more devices. The process may be performed at any computing device having at least one processing device.

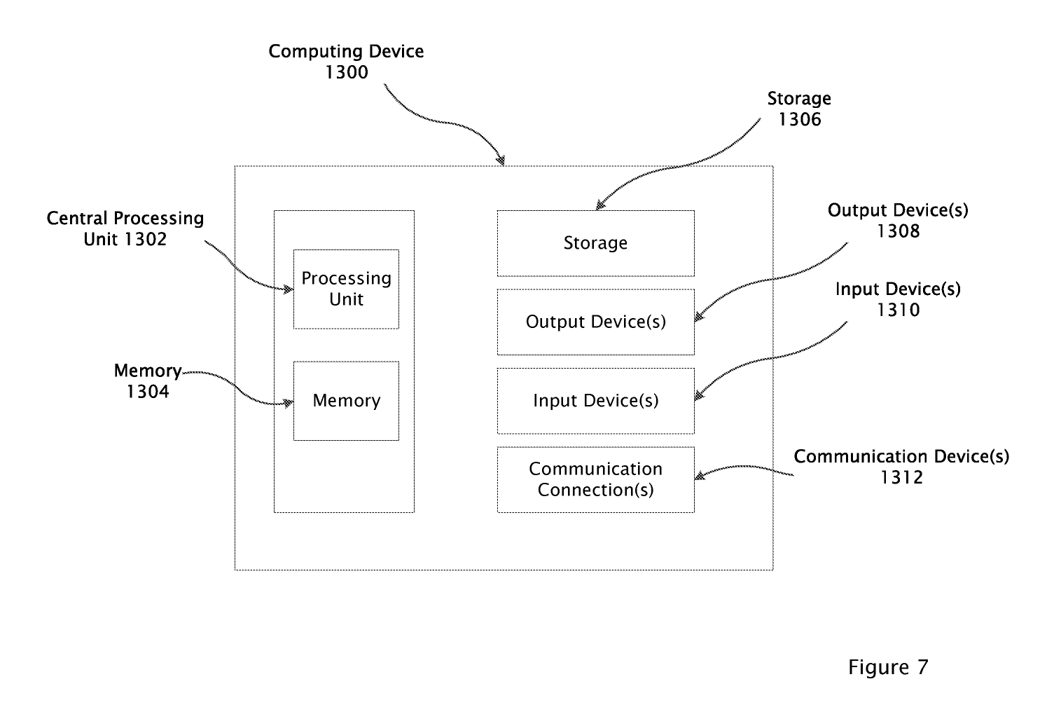

FIG. 7 illustrates a block diagram of a Computing Device (1300) according to one embodiment. The Computing Device (1300) can be utilized to implement one or more computing devices, computer processes, or software modules described herein. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries and hypertext, and compile computer codes.

The Computing Device (1300) can be any general or special purpose computer now known or to become known, capable of performing the steps and/or performing the functions described herein, either in software, hardware, firmware, or a combination thereof.

In its most basic configuration, Computing Device (1300) typically includes at least one Central Processing Unit (CPU) (1302) and Memory module (1304). A Central Processing Unit may be a microprocessor, a microcontroller, or the likes. The Central Processing Unit may also be considered as a processing device or a processing module. Depending on the configuration and type of Computing Device (1300), Memory module (1304) may be volatile (such as RAM), non-volatile (such as ROM, flash memory, etc.) or a combination of the two. Computing Device (1300) may also have additional features/functionality. For example, Computing Device (1300) may include multiple CPUs. The described methods may be executed in any manner by any processing unit in the Computing Device (1300). For example, a described process may be executed by multiple CPUs in parallel.

Computing Device (1300) may also include additional storage module (removable and/or non-removable) including, but not limited to, magnetic or optical disks or tape. Such additional storage is illustrated in FIG. 6 by Storage module (1306). Computer-readable storage media includes volatile and nonvolatile, removable and non-removable media implemented in any method or technology for storage of information such as computer readable instructions, data structures, program modules or other data. A Database Module is an example of a Storage Module. Memory module (1304) and Storage module (1306) are examples of computer storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such Computer-readable storage media may be part of computing device (1300). Computer-readable storage media does not include transient signals.

Computing Device (1300) may also contain Communications Device(s) (1312) that allow the device to communicate with other devices. Communication with other devices may be via a wired or wireless network. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

The Computing Device (1300) may also include other modules to support additional functions. An Access Rights module may be included to control the access rights of each user; a user may be assigned a read only access, or a write and read access, or an administrative access.

Computing Device (1300) may also have an Input Module that includes Input Device(s) (1310) such as keyboard, mouse, pen, voice input device, touch input device, etc. A content receiving module for receiving and sorting content, and user input receiving module for receiving user input may be included in the Input Module. An Output Module that includes Output Device(s) (1308) such as a display, speakers, printer, etc. may also be included. A rendering module to render graphics on a display device may also be included in the Output Module. All these devices are well known in the art and need not be discussed at length.

Those skilled in the art will realize that storage medium utilized to store program instructions can be distributed across a network. For example, a remote computer may store an example of the process described as software. A local or terminal computer may access the remote computer and download a part or all of the software to run the process. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

The illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing device or by distributed processing devices.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended. claims

1. A method for a map of contents, comprising:
creating, by a processing device, a map;
receiving, from a first user, a first content;
correlating the first content with a first area of the map;
receiving, from a second user, an indication selecting the first area of the map; and
upon receiving the indication selecting the first area of the map, presenting the first content to the second user.

2. The method of claim 1, further comprising:
receiving a first input from the first user, the first input identifying a first section of the first area of the map;
receiving a second input from the first user, the second input identifying a second section of the first area of the map; and
calculating a route based upon the identifications of the first and second sections.

3. The method of claim 1 further comprising retrieving, from a storage module coupled to the processing device, a second content, the second content being correlated to the first area of the map; and
in response to receiving the indication selecting the first area, presenting the second content to the second user.

4. The method of claim 1 wherein creating a map comprises:
selecting a graphic for the map; and
dividing the graphic of the map into a plurality of selection areas, the first area being one of the plurality of areas.

5. The method of claim 1 further comprising receiving a second content;
correlating the second content with the first area of the map; and
presenting the second content to the second user.

6. The method of claim 1, wherein the first content is one of a web link, a picture file, a text file, a slide show, a video file and a spreadsheet file.

7. The method of claim 1, wherein receiving the indication selecting the first area comprises:
receiving a first input from the second user, the first input identifying the first area; and
receiving a second input from the second user, the second input selecting the first area.

8. A system comprising:
a processor;
a memory;
modules stored in the memory and executable on the processor, comprising:
a content receiving module configured to receive a content from a first user;
a processing module configured to generate a map graphic having a plurality of selection areas, and correlate the content to a first area of the map graphic, the first area being one of the plurality of selection areas;
a rendering module configured to render the map graphic onto a display device;
an input receiving module configured to receive an indication selecting the first area; and
an output module configured to output the content.

9. The system of claim 8 further comprising a database module configured to store the content.

10. The system of claim 8 further comprising a route generating module, configured to generate and display a route on the map graphic, corresponding to the content.

11. The system of claim 8 wherein the output module generates at least one of an HTML code, an output for viewing on software dedicated to viewing the content, and an output for viewing on a reader device.

12. The system of claim 8 wherein the content is one of a web link, a picture file, a text file, a slide show, a video file and a spreadsheet file.

13. The system of claim 8 wherein the output module is further configured to output, upon the receiving the indication selecting the first area, a list of content associated with the first area.

14. The system of claim 8 wherein the content receiving module is further configured to receive an input from the first user, the input creating an association between the content and the first area.

15. The system of claim 8 wherein the generated graphic map is one of a geographical map and an arbitrary graphic.

16. A non-transitory, computer-readable storage medium containing instructions thereon which, when executed, perform the method comprising:
creating a map;
receiving, from a first user, a first content;
correlating the first content with a first area of the map;
receiving, from a second user, an indication selecting the first area of the map; and
upon receiving the indication selecting the first area of the map, presenting the first content to the second user;

17. The computer-readable storage medium of claim 16, wherein the method further comprises:
receiving a second content;
correlating the second content with the first area of the map; and
upon receiving the indication selecting the first area of the map,
presenting the first content and the second content to the second user.

18. The computer-readable storage medium of claim 16, wherein the first content is one of a web link, a picture file, a text file, a slide show, a video file and a spreadsheet file.

19. The computer-readable storage medium of claim 16, wherein the method further comprises:
dividing the map into a plurality of selection areas, the first area being one of the plurality of selection areas; and
rendering the map for presentation on a display device.

20. The computer-readable storage medium of claim 16, wherein the map is one of a geographical map and an arbitrary graphic.
